(19) United States
(12) Patent Application Publication
(10) Pub. No.: US 2013/0139575 A1
(43) Pub. Date: Jun. 6, 2013

(54) ACOUSTIC PARTICLE SORTING IN MICROFLUIDIC CHANNELS

(71) Applicant: UNIVERSITY OF SOUTHERN CALIFORNIA, Los Angeles, CA (US)

(72) Inventors: Changyang Lee, Los Angeles, CA (US); Jungwoo Lee, Seoul (KR); K. Kirk Shung, Monterey Park, CA (US)

(73) Assignee: UNIVERSITY OF SOUTHERN CALIFORNIA, Los Angeles, CA (US)

(21) Appl. No.: 13/706,135

(22) Filed: Dec. 5, 2012

Related U.S. Application Data
(60) Provisional application No. 61/566,952, filed on Dec. 5, 2011.
(60) Provisional application No. 61/733,614, filed on Dec. 5, 2012.
(60) Provisional application No. 61/585,742, filed on Jan. 12, 2012.

(51) Int. Cl. G01N 29/04

(52) U.S. Cl. CPC G01N 29/04
USPC 73/61.75

(57) ABSTRACT

A method for sensing and sorting single tiny particles in microfluidic channels may comprise subjecting the particles to ultrasound; detecting scattering of the ultrasound from these particles; and pushing or sorting these particles using ultrasound based on the scattered ultrasound that is detected.

### CROSS-REFERENCE TO RELATED APPLICATIONS

This application is based upon and claims priority to U.S. provisional patent application 61/566,952, entitled “Acoustic Particle Sorting in Microfluidic Channels,” filed Dec. 5, 2011, attorney docket number 028080-0697; to U.S. provisional patent application 61/585,742, entitled “Acoustic Particle Sorting in Microfluidic Channels,” filed Jan. 12, 2012, attorney docket number 028080-0703; and to U.S. provisional patent application 61/733,614, entitled “Acoustic Particle Sorting in Microfluidic Channels,” filed Dec. 5, 2012, attorney docket number 028080-0819.

The entire content of each of these applications is incorporated herein by reference.

### STATEMENT REGARDING FEDERALLY SPONSORED RESEARCH

This invention was made with government support under Grant Nos. R01-EB12058 and P41-EB2182, awarded by the National Institutes of Health. The government has certain rights in the invention.

### BACKGROUND

1. Technical Field

Automated and rapid sample preparations have been considered as key components in developing micro total analysis systems (pTAS), for onsite monitoring and diagnosis of various pathogens. Fluorescence-activated cell sorting (FACS), in particular, has allowed fast screening of phenotypically different cells by scanning laser beams, but its implementation may be complicated and costly. Non-invasive acoustic sensing of a single stationary microparticle isolated by acoustic trapping has been previously reported.

2. Description of Related Art

In the past ten years, ‘micro total analysis systems’ (μTAS) have emerged as important tools and technology platforms for the development of point-of-care laboratory tests in the field of biology and medicine. The micro analytical systems have several advantages over macro-scale systems such as lower cost, lower reagent and sample consumption, disposability and portability. Most of analytical processes including micro-PCR (polymerase chain reaction) chips, micro-DNA chips, micro-DNA biosensor, micro-CE (capillary electrophoresis) chips, and micro-protein chip require simple and yet effective methods of obtaining high quality samples [1]. In the micro analytical systems, one of the crucial functions that need to be performed is sample preparation for analysis which must be simple and effective, typically based on the sorting technologies of small particles or cells. Also, automated and rapid sample preparations such as collection, concentration, and separation are all important components in the development of an integrated system for rapid detection and monitoring of all pathogens and environment and diagnosis in onsite. In the past decade, advancements in biology and medicine have led to a significant increase of the number of particle sorting techniques, which provide more efficient monitoring and diagnosis of various illnesses as core tools in μTAS.

During the long history in the development of technologies for the separation of small particles, purification or isolation of particles such as cells has been a major goal for basic research in cell biology, molecular genetics to diagnostics, and therapeutics. In the early stage, available parameters for tiny particle sorting and separation were their physical characteristics or biochemical characteristics such as density, and selectable enzymes [2]. Sorting and separation techniques can be generally grouped into bulk separation and single sorting methods [3]. Single-particle-based sorting is known to be a more sophisticated and conventional method for isolation of single particles and cells, and is a form of flow cytometry, which allows a rapid, objective, and sensitive multiparametric separation.

Conventional methods for single particle sorting are categorized by the mechanisms used for separation and sorting. Fluorescence-activated cell sorting (FACS) utilizes fluorescence resulted from dyes attached or absorbed by cells upon illumination by a laser for cell sensing and static electric charges carried by the cells for sorting. Alternatively, magnetically activated cell separation (MACS), microfludic channel separation using non-inertia force such as dielectrophoretic (DEP) force, magnetic force, optical gradient force, and acoustic primary radiation force all have also been used [4]. However, these methods are by no means perfect. They have limitations in accuracy and speed. Improvements and new approaches are constantly sought. Among the findings it appears that the optical gradient force and acoustic radiation force in continuous flow, which allow both bulk and single cell separation, are the most attractive. Especially, in particle separation via acoustic primary radiation force, Icíar González and his co-workers performed particle sorting by ultrasound in a polymeric chip [5], and Thomas Laurell et al published results on acoustic separation and manipulation of cells and particles using standing wave [6]. Moreover, researchers have shown that these techniques can be applied to biomedical fields. For example, Henrik Jonsson reported that particle separation using ultrasound can be applied in medical surgery [7], and M. Wilklund and H. M. Hertz applied ultrasonic enhancement of particles to bioaffinity assays [8]. Also, Otto Manneberg's group used ultrasound resonances in order to generate ultrasound force fields in microfluidic channels [9]. These researchers all showed that separation and sorting of particles are possible using ultrasound technique.

### SUMMARY

A method for sensing and sorting single tiny particles in microfluidic channels may comprise subjecting the particles to ultrasound; detecting scattering of the ultrasound from these particles; and pushing or sorting these particles using ultrasound based on the scattered ultrasound that is detected.

Previously reported cell sorters that utilized ultrasound resonances were made with standing wave at lower frequencies from 1 KHz to 10 MHz. Acoustic force fields formed by standing wave are not capable of performing single cell sorting because they use pressure nodes which are affected by channel size and ultrasound frequency. In addition, two transducers or one transducer and a strong reflector are needed for such an approach, making its actual implementation quite difficult if not impossible in practical situations. In this patent, a novel method uses radiation forces produced by highly focused high frequency ultrasound beams from 30 MHz to 1 GHz is proposed. Cell or particle sensing can be carried out with conventionally approaches e.g. fluorescence or even ultrasonically via ultrasonic scattering measurements.

In fact ultrasonic sensing would eliminate one major limitation that has plagued conventional devices and methods for single particle or cell sorting i.e., the particles or cells have to be pre-treated. A good example is fluorescence-activated cell sorting (FACS) in which the particles or cells have to be pretreated with fluorescent dye. The proposed technology may allow sensing and sorting of single bioparticles be achieved without pre-treatment. It can make the processes of sorting much simpler. The device of the patent has added advantages in size reduction and ease of operation. FACS device is bulky due to laser sources. The operation of the instrument requires a person with specialized training because of complexity and the requirement for sample pre-treatment. Further, this technique can be employed for sorting and separation in light opaque media.

In comparison to optical radiation force based devices, the proposed technology possesses the following merits: greater radiation forces and penetration of light opaque media.

Ultrasonic sensing can be achieved via a measurement of particle or cell scattering properties which are related to the size as well as acoustic properties of the particles or cells, namely compressibility and density. A number of ultrasonic scattering properties including backscattering, angular scattering, and scattering dependence on frequency may be measured for particle or cell characterization.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates a mode signal difference between 30 μm and 75 μm lipid spheres.

FIG. 2 shows detection sensitivity of the acoustic approach.

FIG. 3 illustrates a microfluidic channel fabricated in poly(dimethyl) siloxane (PDMS) using conventional soft lithography techniques.

FIG. 4 shows a system set-up of an acoustic particle sorting device.

FIG. 5 shows the sensing zone of acoustic particle sorting: (a) the particles pass through portion of the sample solution with width of about 80 μm and flow rate of 1 μl/min.; and (b) the focal point of the transducer is located at the point at 25 μm from left wall of PDMS channel and 20 μm above center line of the channel in order to be positioned at the center of sensing zone.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

### Current State of Development

The development of the proposed technology hinges upon the availability of highly focused high frequency ultrasound transducers. It consists of two phases: sensing and sorting. The particle is first discriminated from its nature and then moved or sorted via ultrasonic radiation force to another channel in a microfluidic environment. As a feasibility study, whether the small particles can be detected and characterized by the scattered signals from the individual particles was investigated. A series of experiments were performed to assess the capability and accuracy of distinguishing particle size from analyzing backscattered signals from particles of different sizes and particle sorting or selection via radiation force. Further experiments are going to be executed in order to improve and evaluate this technology.

### Preliminary Results

### Characterization of Particles from a Mode Signals

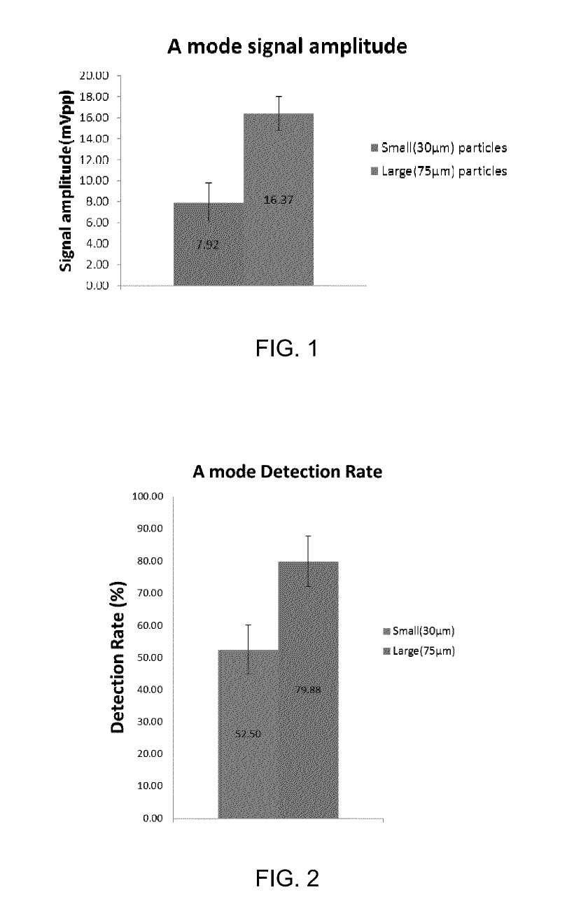

Backscattered signals from lipid droplets of two different sizes, 30 μm and 75 μm, were measured in the microfluidic channel with a very low flow rate using a prototype experimental device. The results shown in FIG. 1 indicate that these lipid spheres can be readily separated by the backscattered echoes measured from these lipid particles. The A mode signals from the smaller particles of 30 μm, were 7.9±1.9 mVₚₚ, while the reflected signals levels of large particles of 75 μm were 16.4±1.6 mVₚₚ, where Vₚₚ denotes peak to peak voltage of the echo amplitude.

### Detection Sensitivity

In order to evaluate the detection sensitivity of the proposed acoustic particle sorting device, Echo amplitudes of echoes and images from a mixture containing oleic acid droplets of 30 μm and 75 μm was flowing through the sensing zone were captured and recorded as movie clips. The total numbers of particles estimated based on movie clips and echo amplitudes of A mode signals were used to calculate the detection sensitivity of the acoustic approach. The total number of particles counted from the movie clips were 1,512 small droplets (30 μm) and 243 large droplets (75 μm), respectively. The small and large particles, detected by the device, were 709 and 187 spheres, respectively. The detection sensitivity was found to be 52.50%±7.68 for the 30 μm droplets and 79.88%±7.82 for the 75 μm droplets. The lower sensitivity for the small particles obviously was caused by the low echo amplitude, which could be remedied by acquiring additional parameters.

The most important component of the technology is a highly focused high frequency ultrasound transducer which is needed for both sensing and sorting of a particle. Other components of the experimental arrangement for feasibility demonstration include a microfluidic channel, a microscope, a motorized linear stage, an oscilloscope, an amplifier and a function generator. A high frequency ultrasound transducer, a microfluidic channel and lipid droplets were custom made for this purpose. Details are given below.

### Fabrication of Ultrasound Transducer

A 30 MHz lithium niobate (LiNbO₃) single element transducer was designed with an F-number of 0.75 by a KLM modeling software (PiezoCAD; Sonic Concepts, USA). The transducer had an aperture size of 4 mm, double matching layers, and a backing medium for acoustic matching, and was press-focused to obtain designed focal length of 3 mm. A 36² rotated Y-cut lithium niobate plate (Boston Piezo-Optics, USA), with thickness of 77 pm and electroplated with 1500 Å chrome/gold (Cr/Au) layer on both sides by an NSC-3000 automatic sputter coater (Nano-Master, USA), was used. First matching layer made from silver epoxy, which was a mixture of Insulcast 501 epoxy (American Safety Technologies, USA) and 2-3 μm silver particles (Aldrich Chemical Co., USA), and lapped to a designed thickness of 12 μm. After lapping, the matching layer was deposited on the piezoelectric plate and mechanically diced into square pieces. The backing layer of a conductive silver epoxy (E-Solder 3022, Von Roll Isola Inc., USA) was deposited on the back side of the lithium niobate. As the last step, the acoustic stack was concentrically placed into the brass housing. The gap between the block and the brass housing was filled with an insulating epoxy (Epo-Tek 301, Epoxy Technologies, USA). After applying mechanical press-focusing [10], the transducer surface was sputtered with Cr/Au electrodes in order to electrically connect ground of the stack with that of the brass housing. Second matching layer of parylene of thickness of 14 μm was deposited by a PDS 2010 Labcoater (SCS, USA). The finished transducer element was connected to an SMA connector.

### Synthesis of Lipid Droplets

Two different size lipid spheres with average diameter of 30 and 75 μm were used for the sorting experiments. The oleic acid (Fisher Scientific, USA) lipid particles were synthesized in poly(dimethyl) siloxane (PDMS) microfluidic channels using conventional soft lithography techniques [11]. The surface of PDMS channels for generating lipid spheres was coated with a hydrophilic surface treatment [12] because of hydrophobic properties of PDMS. The treatment makes the microfluidic channels to continuously generate oleic acid droplet in complete wetting condition of the walls with the aqueous solution. The solution phase consists of a 5 wt % mixture of Pluronic F-68 (Sigma Aldrich, USA) and ultra pure water (Millipore, USA). The lipid droplets are continuously generated by aqueous solution at the shear junction, which the two liquid phases meet, which are cut and formed at a rate of approximately 50 droplets per second. The size is controlled by adjusting the relative flow rates of two solutions for a monodispersed size distribution. Moreover, generated oleic acid droplets are stabilized by Pluronic F-68 during storage and transport.

### Design and Fabrication of Microfluidic Channel

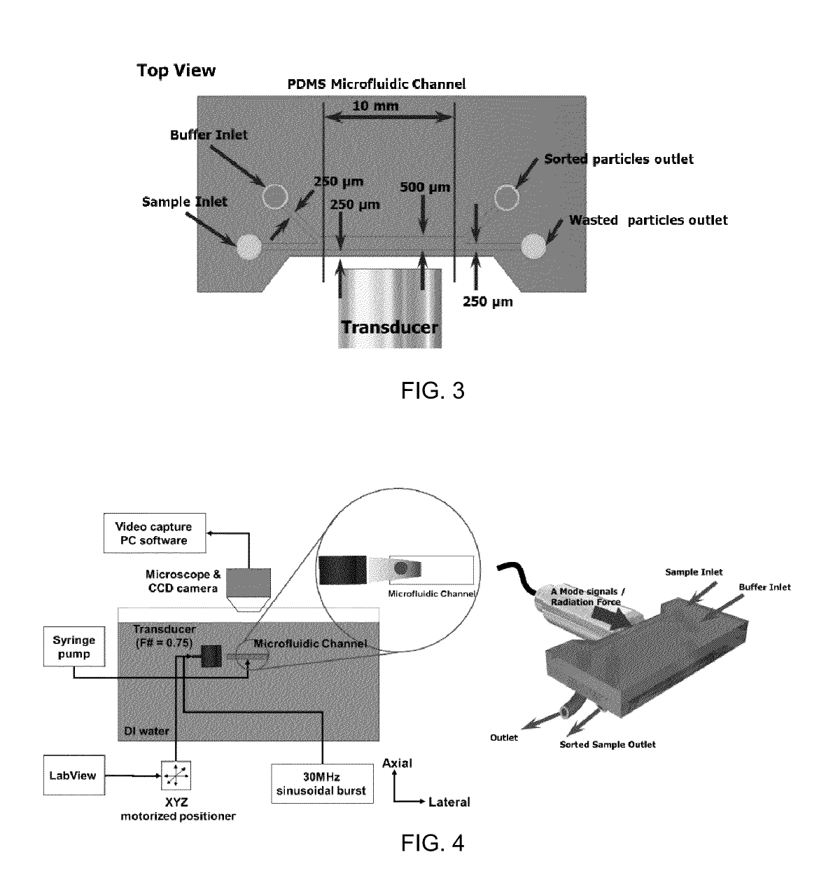

The sorting platform is fabricated in a poly(dimethyl) siloxane substrate. As shown in FIG. 3, the device has two narrow inlet channels leading into a main channel which then splits into two outlet channels. One of two inlet channels serves as flow of sample solution, the other inlet channel serves as flow of buffer solution, providing hydrodynamic positioning of the lipid spheres to the detection area of the main channel. The height of all the channels is 100 μm. The width of the sheath flow channels are 250 μm, the bead inlet channel is 250 μm, main channel is 500 μm, the sorting channel is 250 μm and outlet channels is 250 μm.

Sorting channels were fabricated in poly(dimethyl) siloxane (PDMS) using conventional soft lithography techniques [11]. First, 3 inch silicon wafers were spin-coated with a 100 μm layer of SU8-50 (MicroChem) photoresist, baked to improve the adhesion of the SU-8 to the silicon wafer and then patterned by exposure to UV light through a high resolution photomask containing the channel design. After post-exposure baking, the wafer is then submerged in SU8 developer to expose the channel pattern. The remaining crosslinked SU-8 resist forms a positive mold for the silicone polymer. PDMS (Sylgard 184, Dow Corning) was mixed at a 10:1 prepolymer base to curing agent ratio and poured over the patterned wafer. The polymer mix was cured at 65° for at least 4 hours. After curing the device were peeled off the mold, cut into individual devices and connection holes were bored into the device using flat end dispensing needles (Integrated Dispensing Solutions Inc.). The devices were then cleaned before bonding via oxygen plasma treatment to a cleaned 5 mm thick slab of PDMS. The oxygen plasma activates the surfaces of the PDMS and allows for irreversible bonding between the two surfaces.

A hydrophilic surface treatment is applied to the channels to minimize bubble formation and to match surface wettability since an aqueous continuous phase is used. Polyvinyl alcohol (PVA) hydrophilic treatment is applied to the channels as it has been shown to maintain the PDMS surface hydrophilic for multiple weeks [12]. Briefly, the channels are incubated in a 1 wt. % PVA solution for 5 minutes at room temperature. Then excess solution is removed by vacuum, and the device is incubated in a 120° C. oven for 5 minutes to promote adhesion of the PVA monomers to the PDMS surface. This process can be repeated multiple times to ensure even coating to the surface.

Since there is very little literature on the acoustic transmissibility of the transducer through PDMS, the sorting capability of the transducer was tested for varying PDMS wall thicknesses. The thickness of the wall was 250 μm. It was determined that even with a wall thickness of 250 μm, sufficient ultrasound energy was able to penetrate the wall accomplish the task of pushing the lipid droplet into the desired channel.

### Experimental Setup

To study acoustic particle sensing and sorting with highly focused ultrasound transducers, the experimental equipment was set under distilled water in a chamber. Micro-fluidics channel was fixed in the water chamber. Each flow rate of sample and buffer in microfluidics channel was controlled by syringe pump (NE-1000 Multi-Phaser™; New Era Pump System Inc., N.Y., USA). The ultrasound transducer was assembled at a three-axis motorized linear stage (LMG26 T50 MM; OptoSigma, Santa Ana, Calif., USA) in order to manipulate and locate its position. The transducer was positioned at the side of microfluidics channel in order to detect small particles with A mode signals and to push them with radiation force. The positioner was operated with customized LabVIEW program with RS232C connection. The schematic diagram of sorting device is illustrated in FIG. 4. The highly focused ultrasound transducer was driven by function generator (AFG3251; Tektronix, Anaheim, Calif., USA) and 200 MHz computer controlled pulser/receiver (Model 5900PR; Panametrics-NDT, USA), and then amplified by a 50 dB power amplifier (325LA; ENI, Rochester, USA). A mode echo signals were monitored by oscilloscope (Waverunner 104MXi; LeCory, USA). The video was recorded by a CCD camera (InfinityX; Lumenera, USA) assembled at a microscope (SMZ1500; Nikon, Japan) in order to check out motion of particles related to detect and pushing signals as well as area of detection.

### Experimental Procedure

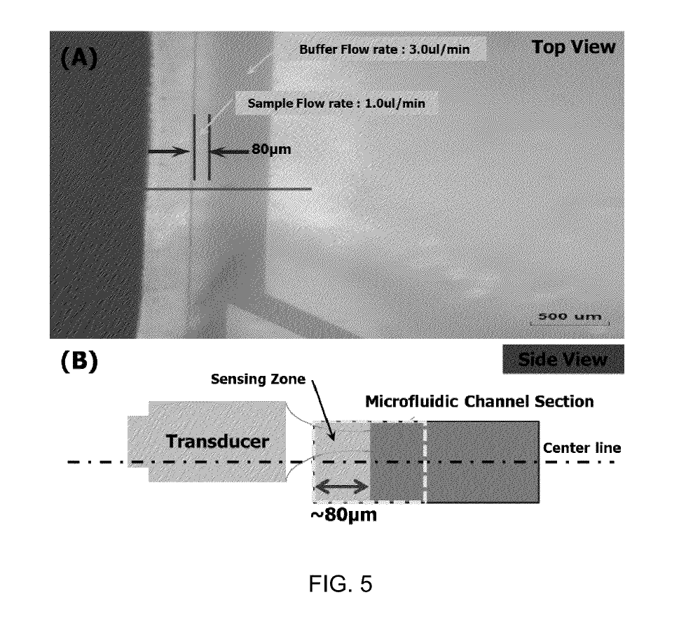

Echo amplitudes detected by the transducer from the particles in microfluidic channel were monitored and analyzed by specialized LabVIEW program. For collecting better signals, the focal point was located at the center of detection area and then particles were passed through that zone by adjusting flow rate of sample and buffer solution. The flow rates of the sample and buffer solution were 1 μl/min and 3 μl/min. The zone and position of the focal point of the transducer are illustrated in FIG. 5.

Movie clips were monitored and recorded with a CCD camera (InfinityX; Lumenera, USA) attached to a microscope (SMZ1500; Nikon, Japan) along with echo amplitudes of the particles.

When the particle was detected at the sensing mode, it was sorted by radiation force generated by the same transducer at the sorting mode. The switching between both modes was controlled by a custom-built LabVIEW program based on the echo amplitude of the particle. The transducer was driven by 30 MHz sinusoidal bursts that consisted of one cycle signal with 32Vₚₚ and 5000 cycles, respectively.

### REFERENCES

All articles, patents, patent applications, and other publications which have been cited are hereby incorporated herein by reference. All of the documents or websites that are cited therein are also incorporated herein by reference in their entirety.

[1] David Erickson, Dongqing Li, “Integrated microfluidic devices, Analytica Chimica Acta,” Microfluidics and Lab-On-a-Chip, Volume 507, Issue 1, Pages 11-26, 2004

[2] Diether Recktenwald and Andreas Radbruch, “Cell Separation Methods and Applications,” Marcel Dekker, Inc., 1998

[3] Alberto Orfao, Alejandro Ruiz-Arguelles, “General Concepts About Cell Sorting Techniques,” Clinical Biochemistry, Volume 29, Issue 1, Pages 5-9, 1996

[4] Hideaki Tsutsui, Chih-Ming Ho, “Cell separation by non-inertial force fields in microfluidic systems,” Mechanics Research Communications, Volume 36, Issue 1, Pages 92-103, 2009

[5] Iciar Gonzalez, Luis Jose Fernandez, Tomas Enrique Gomez, Javier Berganzo, Jose Luis Soto, Alfredo Carrato, “A polymeric chip for micromanipulation and particle sorting by ultrasounds based on a multilayer configuration,” Sensors and Actuators B: Chemical, Volume 144, Issue 1, Pages 310-317, 2010

[6] Laurell T, Petersson F, Nilsson A. “Chip integrated strategies for acoustic separation and manipulation of cells and particles,” Chem Soc Rev., 36(3), Pages 492-506, 2007

[7] Henrik Jonsson, Cecilia Holm, Andreas Nilsson, Filip Petersson, Per Johnsson,

Thomas Laurell, “Particle Separation Using Ultrasound Can Radically Reduce Embolic Load to Brain After Cardiac Surgery,” The Annals of Thoracic Surgery, Volume 78, Issue 5, Pages 1572-1577, 2004

[8] Wiklund M, Hertz H M. “Ultrasonic enhancement of bead-based bioaffinity assays,” Lab Chip., 6(10), Pages1279-1292, 2006

[9] Otto Manneberg, S. Melker Hagsater, Jessica Svennebring, Hans M. Hertz, Jorg P. Kutter, Henrik Bruus, Martin Wiklund, “Spatial confinement of ultrasonic force fields in microfluidic channels,” Ultrasonics, Volume 49, Issue 1, Pages 112-119, 2009

[10] G. G. Lockwood, D. H. Turnbull, and F. S. foster, “Fabrication of high frequency spherically shaped ceramic transducers,” IEEE trans. Ultrason. Ferroelectr. Freq. Control, 41, Pages 231-235, 1994.

[11] Y. N. Xia and G. M. Whitesides, “Soft Lithography,” Annu. Rev. Mater. Sci., 28, Pages 153-184, 1998

[12] M. Kozlov, M. Quarmyne, W. Chen, and T. J. McCarthy, “Adsorption of poly(vinyl alcohol) onto hydrophobic substrates. A general approach for hydrophilizing and chemically activating surfaces,” Macromolecules 36, 6054-6059, 2003

The components, steps, features, objects, benefits and advantages which have been discussed are merely illustrative. None of them, nor the discussions relating to them, are intended to limit the scope of protection in any way. Numerous other embodiments are also contemplated. These include embodiments which have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications which are set forth in this specification are approximate, not exact. They are intended to have a reasonable range which is consistent with the functions to which they relate and with what is customary in the art to which they pertain.

The components, steps, features, objects, benefits and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases in a claim mean that the claim is not intended to and should not be interpreted to be limited to these corresponding structures, materials, or acts or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as first and second and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element proceeded by “a” or “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended embracement of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A method for sensing and sorting single tiny particles in microfluidic channels comprising:
subjecting the particles to ultrasound;
detecting scattering of the ultrasound from these particles; and
pushing or sorting these particles using ultrasound based on the scattered ultrasound that is detected.
